(19) United States
(12) Patent Application Publication
(10) Pub. No.: US 2008/0094282 A1
(43) Pub. Date: Apr. 24, 2008

(54) MULTIPLE INPUT MULTIPLE OUTPUT ANTENNA

(75) Inventor: XIANG-HONG QIN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/615,018

(22) Filed: Dec. 22, 2006

(30) Foreign Application Priority Data
Oct. 20, 2006 (TW) 95138886

(51) Int. Cl. H01Q 1/38

(52) U.S. Cl. 343/700 MS

(57) ABSTRACT

A MIMO antenna (20) disposed on a substrate (10) including a first surface (102) and a second surface (104). The MIMO antenna includes a first antenna (20a) and a second antenna (20b) each including a radiating body (22a), a feeding portion (26a) electrically connected to the radiating body, and a metallic ground plane (24a). The radiating body includes a first radiating portion (222a), a second radiating portion (226a), and a gap (28a) formed between the first radiating portion and the second radiating portion. The radiating body and the feeding portion of the first antenna and the ground plane of the second antenna are laid on the first surface of the substrate, and the radiating body and the feeding portion of the second antenna and the ground plane of the first antenna are laid on the second surface of the substrate.

### BACKGROUND OF THE INVENTION

1. Field of the Invention

The invention relates to multiple input multiple output (MIMO) antennas, and particularly to a MIMO antenna for use in ultra-wideband (UWB) communication systems.

2. Description of Related Art

A frequency band of an UWB wireless communication system is 3.1-10.6 GHz. In a wireless communication system, the antenna is a key element for radiating and receiving radio frequency signals. Therefore, an operating frequency band of the antenna must be 3.1-10.6 GHz or greater. In wireless communications, the number of users continues to increase and data traffic is becoming an increasing more important part of the wireless communication system. Both of these factors mean that it is important for operators to look for methods of increasing the capacity of their wireless communication systems to meet future demands.

A relatively new radio communications technology known as multiple input multiple output (MIMO) systems provides for increased system capacity. A number of antennas are used on both the transmitter and receiver, which together with appropriate beam forming and signal processing technologies are capable of providing two or more orthogonal radio propagation channels between the two antennas. The antennas are spaced apart in order to decorrelate the signals associated with adjacent antennas.

There is a need for improved antenna arrangements for use with UWB MIMO systems.

### SUMMARY OF THE INVENTION

An exemplary embodiment of the present invention provides a MIMO antenna disposed on a substrate including a first surface and a second surface. The MIMO antenna includes a first antenna and a second antenna. The first antenna and the second antenna each include a radiating body for transmitting and receiving radio frequency (RF) signals, a feeding portion for feeding signals, and a metallic ground plane. The radiating body includes a first radiating portion, a second radiating portion, and a gap formed between the first radiating portion and the second radiating portion. The feeding portion is electrically connected to the radiating body. The radiating body and the feeding portion of the first antenna and the ground plane of the second antenna are laid on the first surface of the substrate, and the radiating body and the feeding portion of the second antenna and the ground plane of the first antenna are laid on the second surface of the substrate.

Other advantages and novel features will become more apparent from the following detailed description when taken in conjunction with the accompanying drawings, in which:

### BRIEF DESCRIPTION OF THE DRAWINGS

FIG. 1 is a schematic plan view of a multi input multi output (MIMO) antenna of an exemplary embodiment of the present invention, the MIMO antenna including a first antenna and a second antenna;

FIG. 2 is similar to FIG. 1, but viewed from another aspect;

FIG. 3 is a schematic plan view illustrating dimensions of the first antenna of the MIMO antenna of FIG. 1;

FIG. 4 is a graph of test results showing a voltage standing wave ratio (VSWR) of the first antenna of FIG. 1;

FIG. 5 is a graph of test results showing a VSWR of the second antenna of FIG. 2; and

FIG. 6 is a graph of test results showing an isolation between the first antenna and the second antenna of FIG. 1.

### DETAILED DESCRIPTION OF THE INVENTION

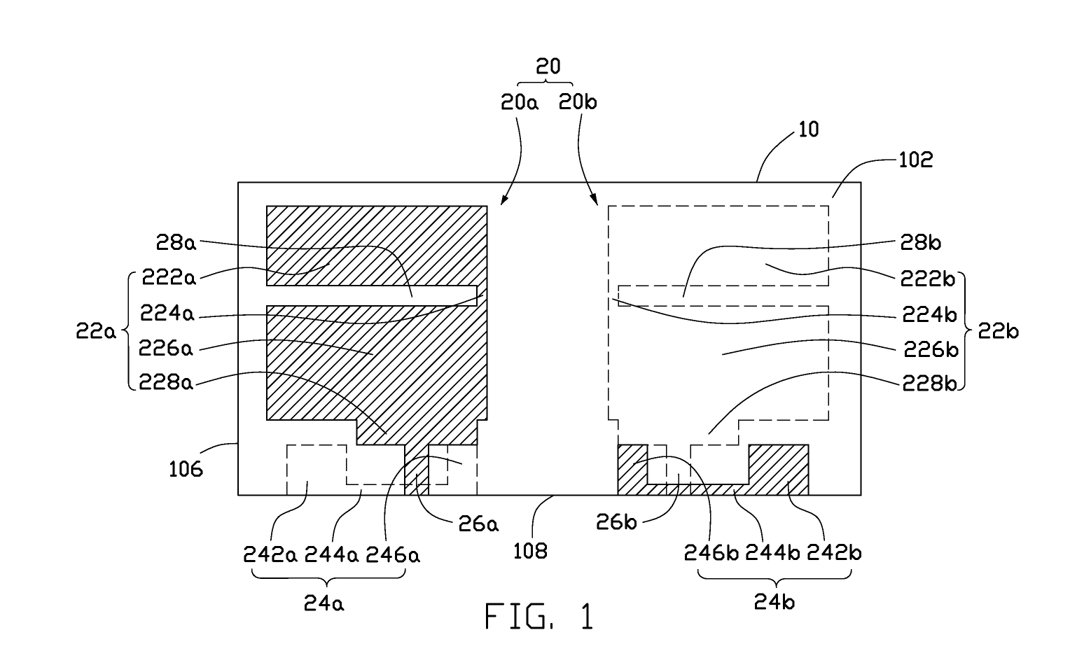

FIG. 1 is a schematic plan view of a multi input multi output (MIMO) antenna 20 of an exemplary embodiment of the present invention. In the exemplary embodiment, the MIMO antenna 20 is printed on a substrate 10.

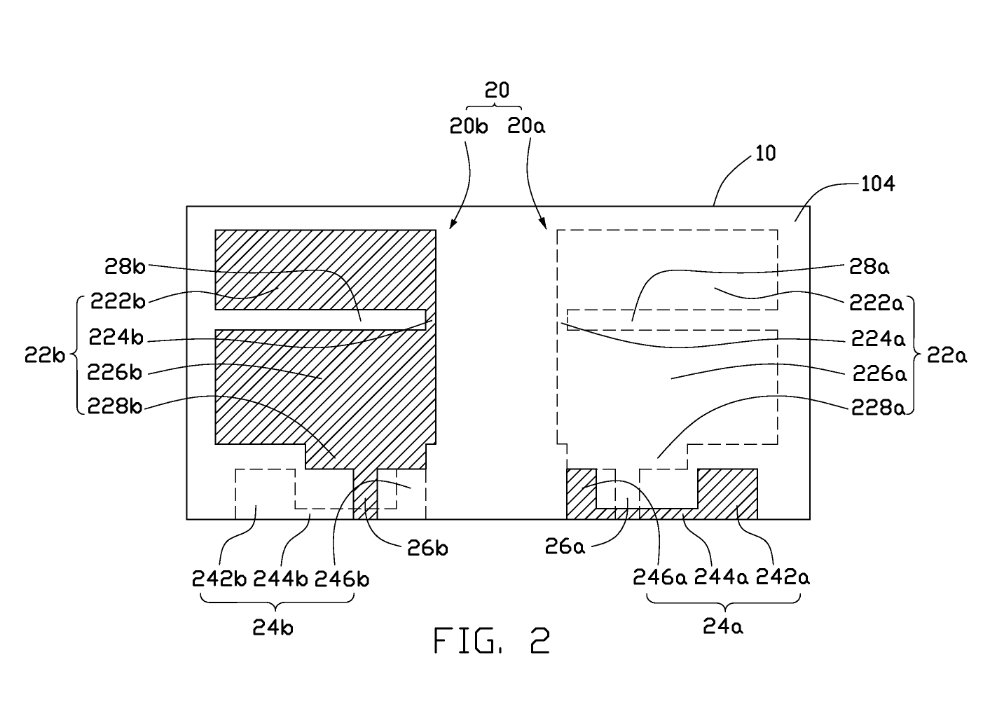

Referring also to FIG. 2, the substrate 10 comprises a first surface 102, a second surface 104 parallel to the first surface 102, a first side 106, and a second side 108 perpendicular to the first side 106.

The MIMO antenna 20 comprises a first antenna 20a and a second antenna 20b.

The first antenna 20a comprises a radiating body 22a, a metallic ground plane 24a, and a feeding portion 26a. The radiating body 22a and the feeding portion 26a are printed on the first surface 102. The ground plane 24a is printed on the second surface 104.

The radiating body 22a transmits and receives radio frequency (RF) signals. The radiating body 22a comprises a first radiating portion 222a, a second radiating portion 226a, a first connecting portion 224a, and a second connecting portion 228a. A gap 28a is formed among the first radiating portion 222a, the second radiating portion 226a, and the first connecting portion 224a, and extends from a side of the radiating body 22a adjacent to the first side 106 of the substrate 10 to the first connecting portion 224a. The first radiating portion 222a is electrically connected to the second radiating portion 226a via the first connecting portion 224a. The second radiating portion 226a is electrically connected to the feeding portion 26a via the second connecting portion 228a. In an alternation embodiment, the first connecting portion 224a is defined as a part of the first radiating portion 222a, and the second connecting portion 228a is defined as a part of the second radiating portion 226a.

The feeding portion 26a is electrically connected to and feeds signals to the second radiating portion 226a. The feeding portion 26a is generally parallel to the first side 106 of the substrate 10, and is a 50Ω transmission line.

The ground plane 24a is adjacent to the second connecting portion 228a, and comprises a rectangular first ground portion 242a, a rectangular second ground portion 246a, and a rectangular third ground portion 244a connecting the first ground portion 242a with the second ground portion 246a. A length of the first ground portion 242a along a direction parallel to the second side 108 is greater than that of the second ground portion 246a.

The second antenna 20b comprises a radiating body 22b, a metallic ground plane 24b, and a feeding portion 26b. The radiating body 22b comprises a first radiating portion 222b, a second radiating portion 226b, a first connecting portion 224b, and a second connecting portion 228b. A gap 28b is formed among the first radiating portion 222b, the second radiating portion 226b, and the first connecting portion 224b. The first radiating portion 222b is electrically connected to the second radiating portion 226b via the first connecting portion 224b. The second radiating portion 226b is electrically connected to the feeding portion 26b via the second connecting portion 228b. The ground plane 24b comprises a first ground portion 242b, a second ground portion 246b, and a third ground portion 244b. Configurations of all elements of the second antenna 20b and relations among the elements of the second antenna 20b are the same as those of the first antenna 20a. The radiating body 22b and the feeding portion 26b of the second antenna 20b are printed on the second surface 104 of the substrate 10. That is, the radiating body 22b and the feeding portion 26b of the second antenna 20b, and the ground plane 24a of the first antenna 20a are laid on the same second surface 104 of the substrate 10. The ground plane 24b of the second antenna 20b is printed on the first surface 104 of the substrate 10. That is, the radiating body 22a and the feeding portion 26a of the first antenna 20a, and the ground plane 24b of the second antenna 20b are located on the same first surface 102 of the substrate 10.

In the exemplary embodiment, the radiating bodys 20a, 20b increase bandwidth of the MIMO antenna 20.

In addition, the MIMO antenna 20 has a low profile and a small size because of the gaps 28a/28b formed between the first radiating portions 222a/222b and the second radiating portions 226a/226b.

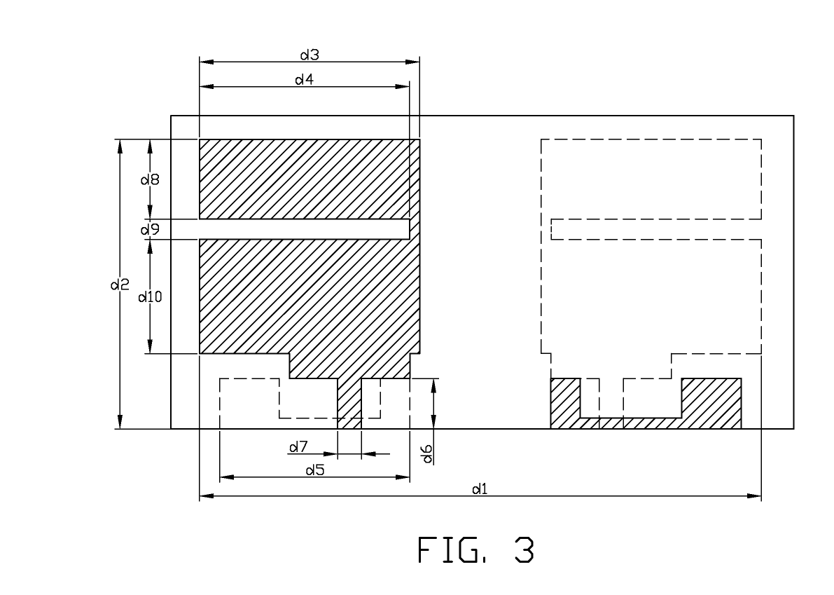

FIG. 3 is a schematic plan view illustrating dimensions of the MIMO antenna 20 of FIG. 1. In the exemplary embodiment, a length d1 of the MIMO antenna 20 is generally 28 mm, and a width d2 of the MIMO antenna 20 is generally 14.5 mm. A width d3 of the radiating body 22a of the first antenna 20a is generally 11 mm. A width d8 of the first radiating portion 222a is generally 4 mm. A width d10 of the second radiating portion 226a is generally 5.75 mm. A length d4 of the gap 28a is generally 10.5 mm. A width d9 of the gap 28a is generally 1 mm. A length d5 of the ground plane 24a is generally 9.5 mm. A width d6 of the ground plane 24a is generally 2.5 mm. A width d7 of the feeding portion 26a is generally 1.2 mm. A length of the feeding portion 26a is generally equal to d6. That is, the length of the feeding portion 26a is equal to the width of the ground plane 24a. Lengths and widths of the all elements of the second antenna 20b are generally equal to those of the first antenna 20a, respectively.

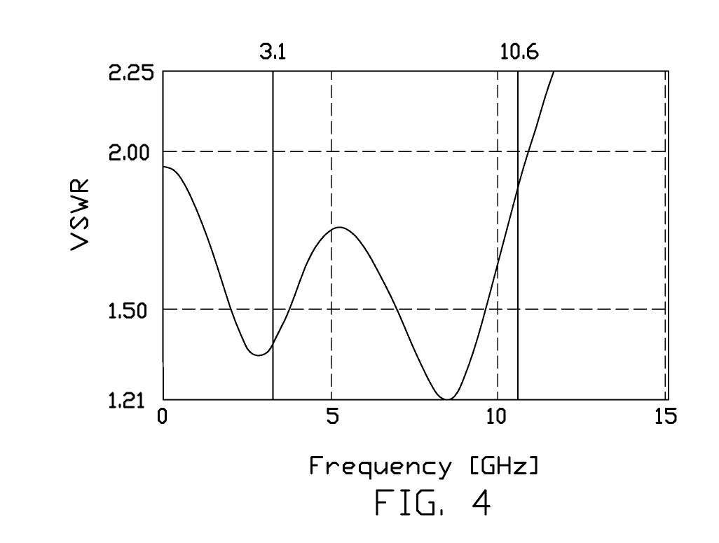

FIG. 4 is a graph of test results showing voltage standing wave ratio (VSWR) at UWB frequencies, of the first antenna 20a. A horizontal axis represents the frequency (in GHz) of the electromagnetic signals traveling through the first antenna 20a, and a vertical axis represents a VSWR. VSWR of the first antenna 20a over the UWB range of frequencies is indicated by a curve. As shown in FIG. 4, the first antenna 20a has a good performance when operating at frequencies from 3.1-10.6 GHz. The amplitudes of the VSWRs in the band pass frequency range are less than 2, which is what is required for an antenna used in UWB systems.

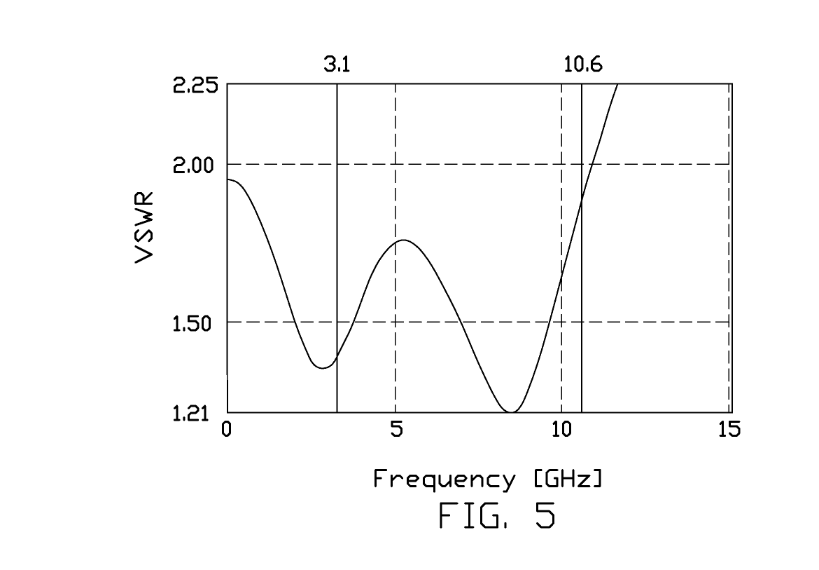

FIG. 5 is a graph of test results showing voltage standing wave ratio (VSWR) at UWB frequencies, of the second antenna 20b. A horizontal axis represents the frequency (in GHz) of the electromagnetic signals traveling through the second antenna 20b, and a vertical axis represents a VSWR. VSWR of the first antenna 20a over the UWB range of frequencies is indicated by a curve. As shown in FIG. 5, the second antenna 20b has a good performance when operating at frequencies from 3.1-10.6 GHz. The amplitudes of the VSWRs in the band pass frequency range are also less than 2.

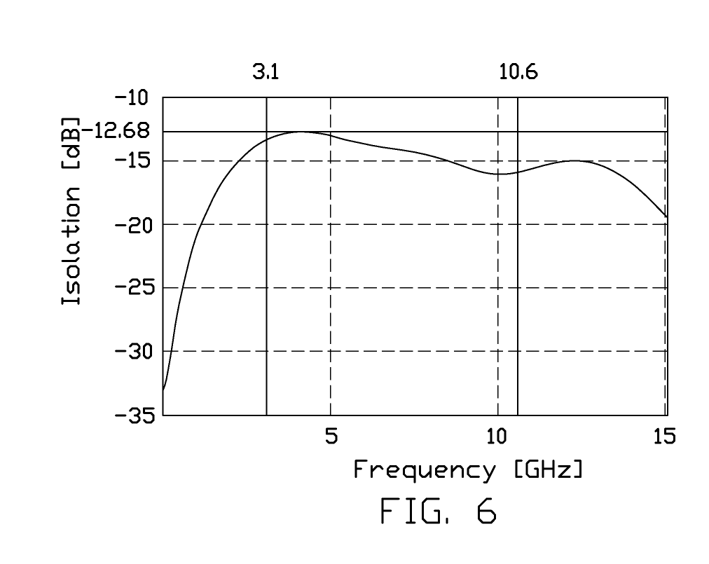

FIG. 6 is a graph of test results showing isolation between the first antenna 20a and the second antenna 20b of the MIMO antenna 20. A horizontal axis represents the frequency (in GHz) of the electromagnetic signals traveling through the MIMO antenna 20, and a vertical axis indicates amplitude of isolation. A curve represents amplitudes of isolation over the range of frequencies. As shown in FIG. 6, the values of isolation never go higher than approximately −12.68 dB over the UWB range of frequencies. The highest isolation value is less than −10, indicating the MIMO antenna 20 is suitable for use in UWB systems.

In this embodiment, the radiating portion 22a of the first antenna 22a and the radiation portion 22b of the second antenna 22b are disposed on different surfaces of the substrate 200, therefore, the isolation between the first antenna 22a and the second antenna 22b is good.

While embodiments of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A multi input multi output (MIMO) antenna printed on a substrate comprising a first surface and a second surface, the MIMO antenna comprising a first antenna and a second antenna, the first antenna and the second antenna each comprising:
a radiating body for transmitting and receiving radio frequency (RF) signals, the radiating body comprising a first radiating portion, a second radiating portion and a first connecting portion electrically connecting the first radiating portion with second radiating portion;
a feeding portion, for feeding signals, the feeding portion electrically connected to the radiating body; and
a metallic ground plane comprising a first ground portion and a second ground portion;
wherein, the radiating body and the feeding portion of the first antenna and the ground plane of the second antenna are printed on the first surface of the substrate, and the radiating body and the feeding portion of the second antenna and the ground plane of the first antenna are printed on the second surface of the substrate.

2. The MIMO antenna as claimed in claim 1, wherein an operating frequency band of the first antenna is 3.1-10.6 GHz.

3. The MIMO antenna as claimed in claim 1, wherein an operating frequency band of the second antenna is 3.1-10.6 GHz.

4. The MIMO antenna as claimed in claim 1, wherein a gap is formed among the first radiating portion, the first connecting portion, and the second radiating portion.

5. The MIMO antenna as claimed in claim 4, wherein the gap separates the first radiating portion and the second radiating portion.

6. The MIMO antenna as claimed in claim 1, further comprising a second connecting portion electrically connecting the feeding portion with the second radiating portion.

7. The MIMO antenna as claimed in claim 1, wherein the ground plane further comprises a third ground portion electrically connecting the first ground portion and the second ground portion.

8. The MIMO antenna as claimed in claim 1, wherein Lengths and widths of all elements of the second antenna are generally equal to those of the first antenna, respectively.

9. The MIMO antenna as claimed in claim 1, wherein the length of the feeding portion is equal to the width of the ground plane.

10. The MIMO antenna as claimed in claim 1, wherein a width of the first radiating portion is generally equal to that of the second radiating portion.

11. A multi input multi output (MIMO) antenna disposed on a substrate comprising a first surface and a second surface, the MIMO antenna comprising a first antenna and a second antenna, the first antenna and the second antenna each comprising:
a radiating body for transmitting and receiving radio frequency (RF) signals, the radiating body comprising a first radiating portion, a second radiating portion, and a gap formed between the first radiating portion and the second radiating portion;
a feeding portion, for feeding signals, the feeding portion electrically connected to the radiating body; and
a metallic ground plane;
wherein, the radiating body and the feeding portion of the first antenna and the ground plane of the second antenna are laid on the first surface of the substrate, and the radiating body and the feeding portion of the second antenna and the ground plane of the first antenna are laid on the second surface of the substrate.

12. The MIMO antenna as claimed in claim 11, wherein an operating frequency band of the first antenna is 3.1-10.6 GHz.

13. The MIMO antenna as claimed in claim 11, wherein an operating frequency band of the second antenna is 3.1-10.6 GHz.

14. The MIMO antenna as claimed in claim 11, wherein the length of the feeding portion is equal to the width of the ground plane.

15. The MIMO antenna as claimed in claim 11, wherein Lengths and widths of all elements of the second antenna are generally equal to those of the first antenna, respectively.

16. The MIMO antenna as claimed in claim 11, wherein the gap partly separates the first radiating portion and the second radiating portion.

17. An assembly comprising:
a substrate comprising a first surface and a second surface opposite to said first surface; and
a multi input multi output (MIMO) antenna disposed on said substrate, said MIMO antenna comprising a first antenna mainly formed on said first surface of said substrate and a second antenna mainly formed on said second surface of said substrate, said first antenna comprising a first feeding portion formed on said first surface for feeding signals to said first antenna, and a first radiating body formed on said first surface and electrically connectable with said first feeding portion to transmit and receive radio frequency (RF) signals for said first antenna, said second antenna comprising a second feeding portion formed on said second surface for feeding signals to said second antenna, and a second radiating body formed on said second surface and electrically connectable with said second feeding portion to transmit and receive radio frequency (RF) signals for said second antenna, said first radiating body and said first feeding portion of said first antenna being spaced from a projection of said second radiating body and said second feeding portion of said second antenna on said first surface of said substrate without overlapping therewith.

18. The assembly as claimed in claim 17, wherein said first antenna comprises a first ground plane formed on said second surface of said substrate next to said second radiating body and said second feeding portion of said second antenna, and said second antenna comprises a second ground plane formed on said first surface of said substrate next to said first radiating body and said first feeding portion of said first antenna.
